(19) United States
(12) Patent Application Publication
(10) Pub. No.: US 2010/0103691 A1
(43) Pub. Date: Apr. 29, 2010

(54) AUTOMOTIVE LAMP WHOSE LIGHT SOURCE IS A SEMICONDUCTOR LIGHT EMITTING DEVICE

(75) Inventors: Yuji YASUDA, Shizuoka (JP); Takashi Inoue, Shizuoka (JP); Seiichiro Yagi, Shizuoka (JP); Junichi Shimizu, Tokyo (JP); Hiroshi Tamaki, Tokyo (JP); Tetsuya Sugiyama, Tokyo (JP)

Correspondence Address: FULWIDER PATTON LLP, HOWARD HUGHES CENTER, 6060 CENTER DRIVE, TENTH FLOOR, LOS ANGELES, CA, 90045, US

(73) Assignee: Koito Manufacturing Co., Ltd., Tokyo (JP)

(21) Appl. No.: 12/604,744

(22) Filed: Oct. 23, 2009

(30) Foreign Application Priority Data
Oct. 24, 2008 (JP) 2008-273850

(51) Int. Cl. B60Q 1/00

(52) U.S. Cl. 362/547

(57) ABSTRACT

An automotive lamp includes a semiconductor light emitting device used as a light source and bracket used as a support member supporting the semiconductor light emitting device. The bracket includes a first heat-transfer member having an isotropic thermal conductivity in at least part of region in contact with the semiconductor light emitting device, and a second heat-transfer member having an anisotropic thermal conductivity in a region in contact with the first heat-transfer member.

### CROSS-REFERENCE TO RELATED APPLICATIONS

This application is based upon and claims the benefit of priority from the prior Japanese Patent Application No. 2008-273850, filed on Oct. 24, 2008, the entire content of which is incorporated herein by reference.

### BACKGROUND OF THE INVENTION

1. Field of the Invention

The present invention relates to an automotive lamp and, in particular, to an automotive lamp whose light source is a semiconductor light emitting device.

2. Description of the Related Art

In recent years, proposed are automotive lamps that use a semiconductor light emitting device, such as an LED (light emitting diode), as the light source. When a semiconductor light emitting device is used as the light source for an automotive lamp, the level of light intensity required of the automotive lamp needs to be satisfied by a maximum use of the light emission from the semiconductor light emitting device. In other words, the required level of light intensity cannot be met unless the light emission therefrom is used at its maximum capacity.

Generally, a semiconductor light emitting device produces more heat for larger current which is supplied to obtain a greater output. And this correspondingly lowers the luminance efficiency of the semiconductor light emitting device as it gets hotter due to the heating. Thus, there have been various heat radiation structures for automotive lamps in order to radiate heat from the semiconductor light emitting device efficiently. For example, Japanese Patent Application Publication No. 2004-214144 discloses such a technique. In this known technique, a support member supporting the semiconductor light emitting device is formed of a metal, such as aluminum, which excels in heat radiation performance, and the heat produced by the semiconductor light emitting device is efficiently diffused through a metallic support member. Hence, the rise in temperature of the semiconductor light emitting device is suppressed in this technique.

Also, in recent years, reduction in weight of a vehicle is required with a view to improving fuel efficiency and motion performance of a vehicle, which in turn requires a lighter-weight automotive lamp. Under such circumstances, the inventors of the present invention have come to recognize the following problem to be solved. That is, a method for reducing the weight of an automotive lamp is conceivable in which the support member supporting the semiconductor light emitting device is replaced with a material, such as carbon fiber reinforced plastic (CFRP), which is lighter than the metal (e.g., aluminum).

CFRP is structured such that a plurality of laminated core materials (prepregs) are stacked together wherein the core material is formed such that a plurality of carbon fibers are bonded together using thermosetting resin or the like. CFRP has an anisotropic thermal conductivity. That is, the heat does not easily propagate in the stacking direction of core material, whereas the heat easily propagates in an extending direction of core material. Accordingly, where CFRP is used as the supporting member of the semiconductor light emitting device, there is a problem that the heat produced by the semiconductor light emitting device cannot be efficiently diffused as compared to the support member made of a metal, such as aluminum, having an isotropic thermal conductivity.

### SUMMARY OF THE INVENTION

The present invention has been made in view of the inventors' recognition described as above, and one of the purposes thereof is to provide a technology for making an automotive lamp lightweight and diffusing efficiently the heat produced by a semiconductor light emitting device used as a light source.

To resolve the foregoing problems, an automotive lamp according to one embodiment of the present invention comprises: a semiconductor light emitting device used as a light source; and a support member which supports the semiconductor light emitting device, wherein the supporting member includes a first heat-transfer member having an isotropic thermal conductivity in at least part of region thereof in contact with the semiconductor light emitting device, and a second heat-transfer member having an anisotropic thermal conductivity in a region thereof in contact with the first heat-transfer member.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is a schematic horizontal cross-sectional view of an automotive lamp according to a first embodiment of the present invention;

FIG. 2 is a cross-sectional view taken along the line A-A of FIG. 1;

FIG. 3 schematically shows a structure of a bracket;

FIG. 4 is a partially enlarged cross-sectional view taken along the line A-A of FIG. 1;

FIG. 5 is a schematic illustration showing a state where a securing member is provided;

FIGS. 6A and 6B are schematic illustrations to explain a first modification of a first embodiment;

FIG. 7 is a schematic vertical cross-sectional view of an automotive lamp according to a first modification of a first embodiment;

FIGS. 8A and 8B are schematic illustrations to explain a second modification of a first embodiment;

FIG. 9 is a schematic horizontal cross-sectional view of an automotive lamp according to a second embodiment of the present invention;

FIG. 10 is a cross-sectional view taken along the line B-B of FIG. 9;

FIG. 11 is a schematic illustration showing a structure of a bracket; and

FIGS. 12A and 12B are schematic illustrations to explain a modification of a second embodiment.

### DETAILED DESCRIPTION OF THE INVENTION

The invention will now be described by reference to the preferred embodiments. This does not intend to limit the scope of the present invention, but to exemplify the invention.

Hereinbelow, The embodiments will now be described with reference to drawings. Note that in all of the Figures the same structural components, members and processings are given the same reference numerals and the repeated description thereof is omitted as appropriate. Moreover, the embodiments given are for illustrative purposes only and all features and their combination thereof described in the present embodiments are not necessarily essential to the invention.

### First Embodiment

The present embodiment relates to an automotive lamp comprising a semiconductor light emitting device used as a light source, and a support member that supports the semiconductor light emitting device. In the automotive lamp according to the present embodiment, the supporting member includes a first heat-transfer member by which to diffuse heat produced by the semiconductor light emitting device, and a second heat-transfer member, having an anisotropic thermal conductivity, disposed in contact with the first heat-transfer member. The first heat-transfer member diffuses the heat of the semiconductor light emitting device in a direction where the heat produced by the semiconductor light emitting device is not easily diffused due to the anisotropic thermal conductivity of the second heat-transfer member. As a result, the heat produced by the semiconductor light emitting device is diffused efficiently.

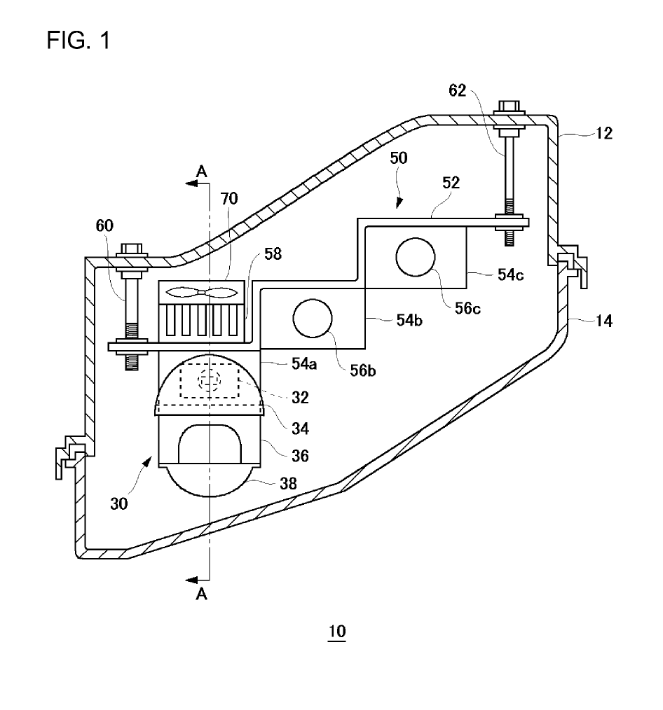

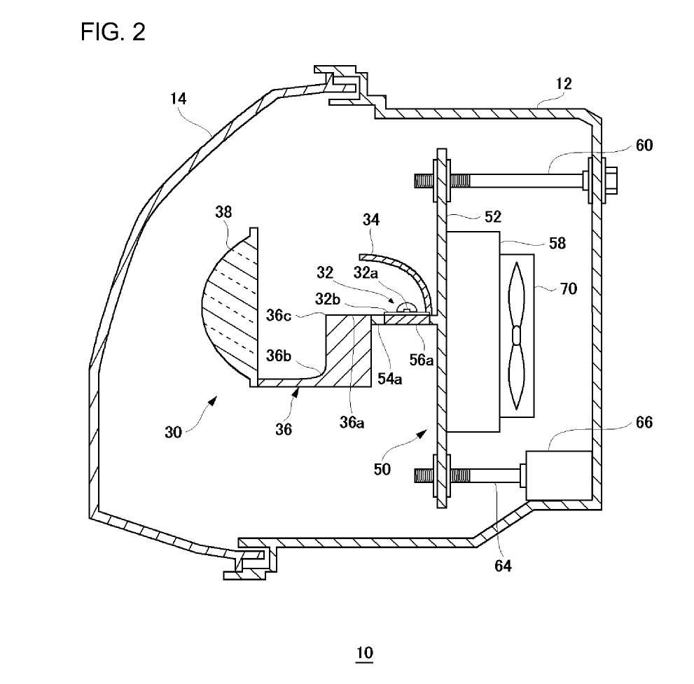

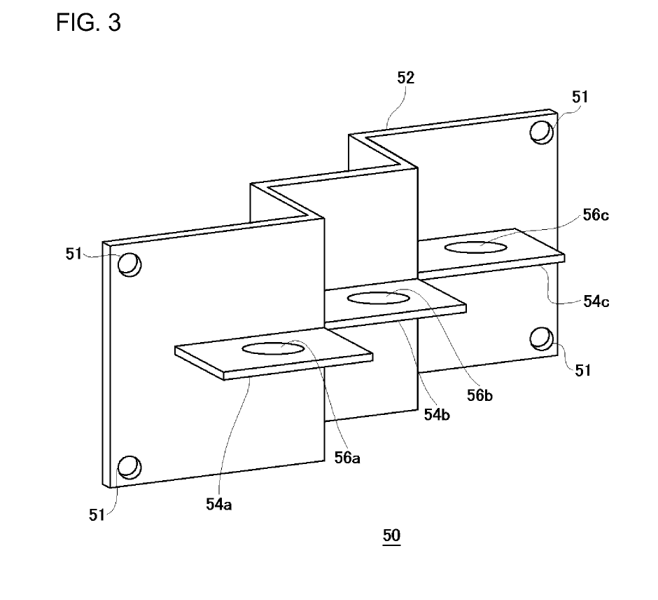

FIG. 1 is a schematic horizontal cross-sectional view of an automotive lamp according to a first embodiment of the present invention. FIG. 2 is a cross-sectional view taken along the line A-A of FIG. 1. FIG. 3 is a schematic illustration showing a structure of a bracket. FIG. 1 shows an example of an automotive lamp mounted in a left-side front part of a vehicle. An automotive lamp disposed in a right side front part thereof is arranged line-symmetrically to the structure shown in FIG. 1.

As shown in FIG. 1 and FIG. 2, an automotive lamp 10 according to the first embodiment is structured such that a lamp unit 30 including a semiconductor light emitting device 32 used as a light source is housed within a lamp chamber formed by the a lamp body 12 and a translucent cover 14 installed on a front-end opening of the lamp body 12. Contained within the lamp chamber is a bracket 50 serving as a support member that supports the semiconductor light emitting device 32. The lamp unit 30 is fixed to the bracket 50.

The lamp unit 30, which is a reflective projector-type lamp unit, includes a semiconductor light emitting device 32 and a reflector 34 that reflects light emitted from the semiconductor light emitting device 32 in the frontward direction of a vehicle. Also, the lamp unit 30 includes a shade 36 fixed to the bracket 50 and a projection lens 38 held by the shade 36.

The semiconductor light emitting device 32 is a light emitting diode (LED), for instance. And the semiconductor light emitting device 32 comprises a light emitting chip 32a covered with an approximately hemispherical cap, and a thermally conductive insulating substrate 32b formed of a ceramic or the like. The light emitting chip 32a is disposed on the thermally conductive substrate 32b. The semiconductor light emitting device 32 is placed on each of light source mounting parts 54a to 54c (described later) of the bracket 50 such that the illumination axis of the light emitting device 32 faces upward along an approximately vertical direction which is approximately vertical to an irradiation direction (leftward in FIG. 2) of the lamp unit 30. Note the illumination axis of the semiconductor light emitting device 32 is adjustable according to the shape thereof and the light distribution in the forward direction thereof. Also, the semiconductor light emitting device 32 may be structured such that a plurality of light emitting chips 32a are provided.

The reflector 34 is a reflector member formed such that a reflective surface thereof, which is constituted by a part of an ellipsoid of revolution, for instance, is formed inside the reflector 34 and one end thereof is fixed to the bracket 50. The shade 36 includes a planar part 36a and a bent part 36b. The planar part 36a is disposed approximately horizontally. The area in front of this planar part 36a is bent downward in a recessed manner and is structured as the bent part 36b. And the bent part 36b occupying the front part of the shade 36 is structured so that light irradiated from the semiconductor light emitting device 32 is not reflected. The reflector 34 is designed and arranged such that the first focal point thereof is positioned near the semiconductor light emitting device 32 and that the second focal point thereof is positioned near a ridge line 36c formed by the planar part 36a and the bent part 36b in the shade 36.

The projection lens 38 is a plano-convex aspheric lens, having a convex front surface and a plane rear surface, which projects the light reflected by the reflective surface of the reflector 34 toward a front area of the lamp. The projection lens 38 is disposed on a light axis extending in frontward and rearward directions of a vehicle, and is fixed to the tip end of the shade 36 in a front side of a vehicle. A rear focal point of the projection lens 38 is configured, for instance, such that the rear focal point thereof approximately matches the second focal point of the reflector 34. Also, the projection lens 38 is configured such that an image on a rear focal point face containing the rear focal point is projected onto a vertical virtual screen disposed in front of the lamp, as a reverted image.

The light emitted from the light emitting chip 32a of the semiconductor light emitting device 32 is reflected by the reflective surface of the reflector 34 and enters the projection lens 38 after passing through the second focal point. The light having entered the projection lens 38 is collected by the projection lens 38 so as to be irradiated frontward as approximately parallel light beams. Also, part of light beams are reflected by the planar part 36a with the ridge line 36c of the shade 36 as a boundary, so that the light beams are selectively cut and therefore a diagonal cut-off line is formed in a light distribution pattern projected onto a front part of a vehicle.

As shown in FIG. 1 to FIG. 3, a bracket 50 comprises an approximately plate-like body 52 which is bent a plurality of times as viewed in a horizontal cross-section, and light source mounting parts 54a to 54c, protruded from one face of the body 52, which has a surface along a protruding direction on which the semiconductor light emitting device 32 is each mounted.

The body 52 has screw holes 51 at predetermined peripheral positions thereof. The bracket 50 is fit to the lamp body 12 in a manner such that the screw holes 51 are engaged and screwed with aiming screws 60 and 62 and a leveling shaft 64, which extend forward and penetrate through the lamp body 12. The leveling shaft 64 is connected to a leveling actuator 66. The automotive lamp 10 is structured such that the light axis of the lamp unit 30 is adjustable in the horizontal or vertical direction by the use of the aiming screws 60 and 62, the leveling shaft 64 and the leveling actuator 66.

The bracket 50 includes the three light source mounting parts 54a to 54c, so that three lamp units 30 can be mounted on the bracket 50. Note that only the lamp unit 30, which is mounted on the light source mounting part 54a, is shown in FIG. 1 and the other lamp units 30 placed on the light source mounting part 54b and the light source mounting part 54c are omitted in FIG. 1. In the light source mounting parts 54a to 54c, at least part of region thereof in contact with the semiconductor light emitting device 32 includes first heat-transfer member regions 56a to 56c formed of the first heat-transfer member, made of a metal such as aluminum, having an isotropic thermal conductivity. Regions in contact with the first heat-transfer members of the light source mounting parts 54a to 54c (e.g., the regions thereof other than the first heat-transfer member regions 56a to 56c) are formed of the second heat-transfer member having an anisotropic thermal conductivity. The body 52 is formed of the second heat-transfer member.

It is preferable that most of the bracket 50, about 80% or more in volume fraction, for instance, be formed of the second heat-transfer member.

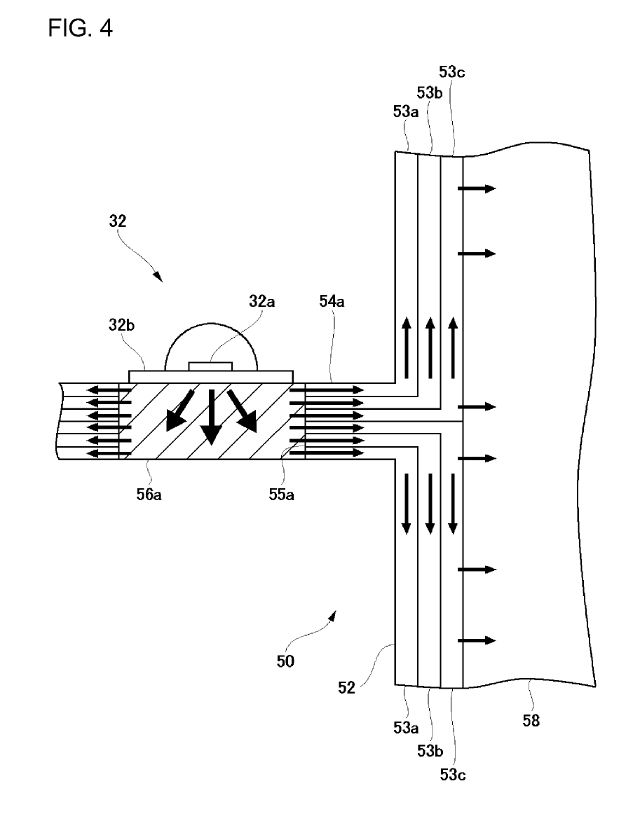

FIG. 4 is a partially enlarged cross-sectional view taken along the line A-A of FIG. 1.

The second heat-transfer member (See FIG. 3), which constitutes the body 52 and the regions, other than the first heat-transfer member regions 56a to 56c, of the light source mounting parts 54a to 54c, is a material whose mass is lighter than the first heat-transfer member and an example thereof is carbon fiber reinforced plastic (CFRP). It is preferable that CFRP contains carbon fibers, having a thermal conductivity of about 320 W/mK or more, the volume fraction of which is about 20% or more. More preferably, CFRP contains carbon fibers, having a thermal conductivity of about 500 W/mK or more, the volume fraction of which is about 50% or more.

The second heat-transfer member is of a multilayered structure where core materials (core layers) are stacked in layers. The core materials are such that the multiple carbon fibers are arranged approximately in parallel with one another, and have an approximately sheet-like shape where the respective carbon fibers are bonded together using thermosetting resin such as epoxy resin. The second heat-transfer member has a high thermal conductivity in the extending direction of core material and a low thermal conductivity in the stacking direction thereof. In other words, the second heat-transfer member has a property of high thermal conductivity within the core material and low thermal conductivity between the core materials. That is, the second heat-transfer member has an anisotropic thermal conductivity in the extending direction of core material. Specifically, the thermal conductivity of the second heat-transfer member in the extending direction of core material is higher than that of the first heat-transfer member, whereas the thermal conductivity of the second heat-transfer member in the stacking direction of core material is lower than that of the first heat-transfer member.

As shown in FIG. 4, in the first embodiment the body 52 and the regions, other than the first heat-transfer member region 56a, of the light source mounting part 54a are formed of the second heat-transfer member which is structured by stacking the core materials 53a to 53c. For example, the light source mounting part 54a is formed such that the core materials 53a to 53c are spread in an approximately vertical direction from one main surface of the approximately plate-like body 52 comprised of core materials 53a to 53c stacked together. Thus the core materials 53a to 53c are continuously formed from the body 52 to the light source mounting part 54a. In other words, the core materials 53a to 53c extend from the body 52 to the light source mounting part 54a.

The light source mounting part 54a has through-holes 55a in a device placement region of the semiconductor light emitting device 32. The first heat-transfer member region 56a is formed in such a manner that the first heat-transfer member is fit into the through-holes 55a. Accordingly, the first heat-transfer member is provided in the light source mounting part 54a so that the first heat-transfer member is interwoven with a plurality of core materials, and the first heat-transfer member and the second transfer member are in contact with each other. It is to be noted that, instead of the through-hole 55a, a recess (e.g., grooves) may be formed in the light source mounting part 54a, and the first heat-transfer member region 56a may be formed by fitting the first heat-transfer member into the recess.

As shown in FIG. 1, FIG. 2 and FIG. 4, a heat radiation fin 58 is provided on a face of the body 52 opposite to the face thereof on which the light source mounting parts 54a to 54c are formed. As shown in FIG. 1 and FIG. 2, provided inside the lamp chamber is a fan 70 that sends air toward the heat radiation fin 58 and thereby cools the heat radiation fin 58. Note that only the heat radiation fin 58 and fan 70 corresponding to the light source mounting part 54a are shown in FIG. 1.

A description is now given of a mechanism for radiating the heat produced by the semiconductor light emitting device 32 structured as above. As indicated by arrows in FIG. 4, the heat produced by the semiconductor light emitting device 32 first diffuses isotropically within the first heat-transfer region 56a which is in contact with the semiconductor light emitting device 32. This is because the first heat-transfer member has an isotropic thermal conductivity. Then the heat inside the first heat-transfer member region 56a is conducted to a plurality of core materials 53a to 53c in the second heat-transfer member which is in contact with the first heat-transfer member. The heat transferred to the core materials 53a to 53c moves inside each core material and diffuse anisotropically within the light source mounting part 54a. Then the heat inside the light mounting part 54a moves within the core materials 53a to 53c which are continuously formed to the body 52 from the light source mounting part 54a, and diffuses into the body 52. The heat diffused to the body 52 from the light source mounting part 54a is conducted to the heat radiation fin 58 where heat is exchanged between the heat transferred and the air sent from the fan 70.

Now, consider a case where the semiconductor light emitting device 32 is placed on the light source mounting part formed of the second heat-transfer member only. In such a case, the diffusion of heat produced by the semiconductor light emitting device 32 is characterized by the anisotropic thermal conductivity of the second heat-transfer member. Thus the heat produced thereby conducts to the outermost core material but does not easily conduct to the other core materials. For that reason, the outermost core material mainly contributes to the diffusion of heat produced by the semiconductor light emitting device 32 while the other core materials have little contribution to the diffusion thereof. Thus the heat produced by the semiconductor light emitting device 32 does not diffuse efficiently and the heat produced thereby stays on in the vicinity of the semiconductor light emitting device 32. As a result, there is a possibility that the temperature of the semiconductor light emitting device 32 may rise excessively.

In the first embodiment, on the other hand, the first heat-transfer member region 56a is provided in a region in contact with the semiconductor light emitting device 32. Here, the first heat-transfer member, whose thermal conductivity is higher than that among the core materials formed of the second heat-transfer member, having an isotropic heat conductivity is fit into the first heat-transfer member region 56a. The first heat-transfer member is so provided as to interlock with a plurality of core materials. This structure allows the heat produced by the semiconductor light emitting device 32 to conduct to each core material through the medium of the first heat-transfer member, so that a plurality of core materials in contact with the first heat-transfer member can contribute to the diffusion of heat. Accordingly, the heat produced by the semiconductor light emitting device 32 can be efficiently diffused in a direction away from the semiconductor light emitting device 32, so that the rise in temperature of the semiconductor light emitting device 32 can be suppressed.

According to the first embodiment, the thermal conductivity of the core material formed of the second heat-transfer member is higher than that of the first heat-transfer member. Thus the heat conducted to each core material from the first heat-transfer member conducts quickly within each core material in a direction away from the semiconductor light emitting device 32. This allows more efficient diffusion of heat produced by the semiconductor light emitting device 32.

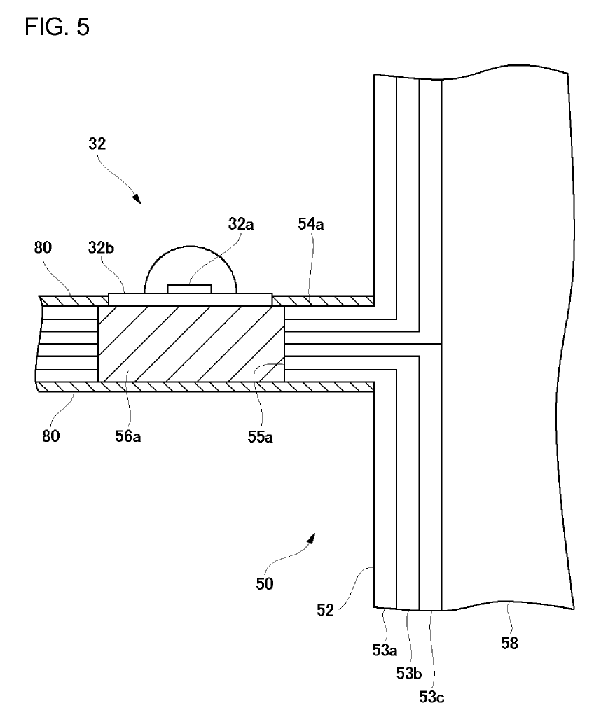

As shown in FIG. 5, a sheet-like securing member 80 may be so provided as to cover the surface of the light source mounting part 54a and the surface of the first heat-transfer member region 56a. Though not shown in FIG. 5, the similar structure is applied to the light source mounting parts 54b and 54c and the first heat-transfer member regions 56b and 56c. By employing this structure, the first heat-transfer member and the second heat-transfer member are fixed relative to each other by the use of the securing member, so that the first heat-transfer member can be prevented from falling off from the second heat-transfer member. The shape of the securing member 80 is not limited to any particular one. For example, screw holes are disposed so that the axes of the screw holes coincide with the first heat-transfer member and the second heat-transfer member, respectively, and the first heat-transfer member and the second heat-transfer member are fixed by inserting the screws into these screw holes. FIG. 5 is a schematic illustration showing how a securing member 80 is provided.

Also, the heat radiation fin 58 may be interwoven with each core material constituting the body 52 in a manner such that an end of the heat radiation fin 58 on a body 52 side is buried into or penetrated through the body 52. This structure enables the heat conducted to each core material from the semiconductor light emitting device 32, to conduct more efficiently to the heat radiation fin 58.

To sum up the operations performed in relation to and the advantages achieved by the structure as heretofore described, the first heat-transfer member regions 56a to 56c formed of the first heat-transfer member having an isotropic thermal conductivity are provided in the light source mounting parts 54a to 54c of the bracket 50. Also, the regions, other than the first heat-transfer member regions 56a to 56c, of the bracket 50 are formed of the second heat-transfer member having an anisotropic thermal conductivity and a lighter weight than the first heat-transfer member. As a result, the automotive lamp 10 is lightweight and the heat produced by the semiconductor light emitting device 32 can be efficiently diffused.

The semiconductor light emitting device 32 such an LED has a property that the luminance efficiency of the semiconductor light emitting device 32 deteriorates as the temperature thereof rises. Since the automotive lamp 10 according to the first embodiment suppresses an excessive rise in temperature of the semiconductor light emitting device 32, the drop in luminance efficiency of the semiconductor light emitting device 32 can be suppressed. As a result, the product reliability of the automotive lamp 10 using the semiconductor light emitting device 32 as a light source can be improved.

In the automotive lamp 10, the first heat-transfer members are arranged such that the first heat-transfer member is interwoven with a plurality of core materials constituting the second heat-transfer member. This structure allows a plurality of core materials to contribute to diffusing the heat produced by the semiconductor light emitting device 32, so that the heat can be diffused more efficiently. Since the core materials 53a to 53c are continuously formed between the body 52 and the light source mounting parts 54a to 54c, the heat can be efficiently diffused from the light source mounting parts 54a to 54c to the body 52.

Consider a case where most of the bracket 50, about 80% or more in volume, for instance, is formed of the second heat-transfer member or a case where CFRP, which is a second heat-transfer member, preferably contains carbon fibers, of about 20% or more in volume fraction, having a thermal conductivity of about 320 W/mK or more, or, more preferably contains carbon fibers, of about 50% or more in volume fraction, having a thermal conductivity of about 500 W/mK or more. In either case, the automotive lamp 10 can be made lighter weight and the thermal conductivity of the automotive lamp 10 can be further improved.

Furthermore, in the automotive lamp 10 a laying surface on which a semiconductor light emitting device 32 is to be placed is provided on each of the first heat-transfer member regions 56a to 56c formed of the first heat-transfer member. The first heat-transfer member such as a metal is easily processed as compared with the second heat-transfer member such as CFRP. As a result, the positioning and the like of the semiconductor light emitting device 32 can be performed more easily and therefore the rise in the number of manufacturing processes and the manufacturing cost can be suppressed. Also, the provision of the securing member 80 that fixes the first heat-transfer member and the second heat-transfer member relative to each other prevents the first heat-transfer member from falling off from the second heat-transfer member.

### MODIFICATIONS

The following modifications of the automotive lamp 10 according to the first embodiment are now described here.

### First Modification

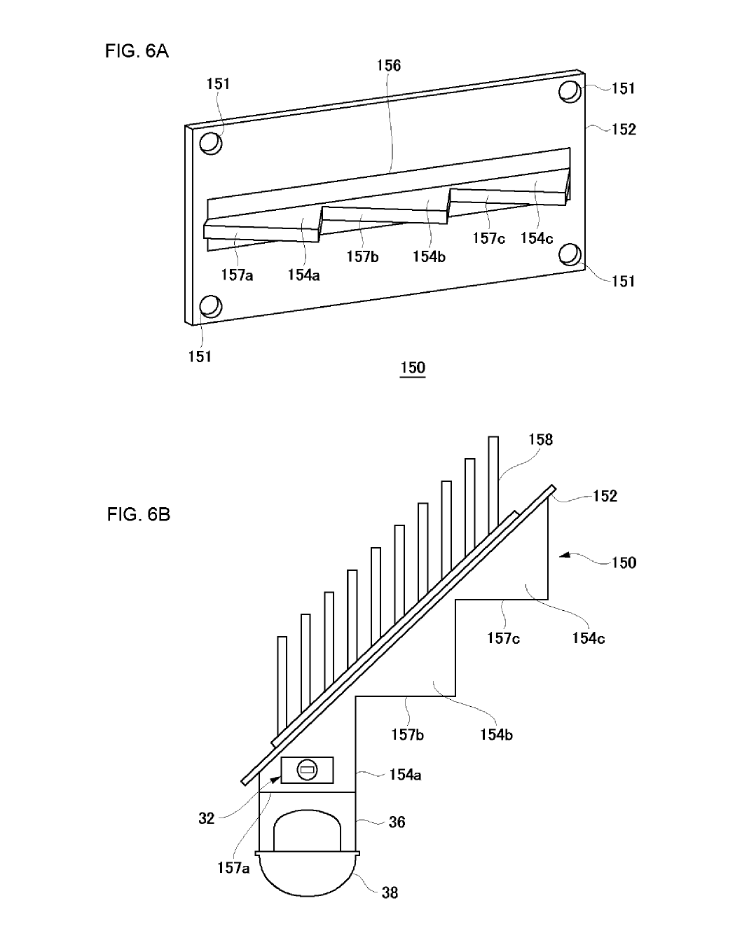

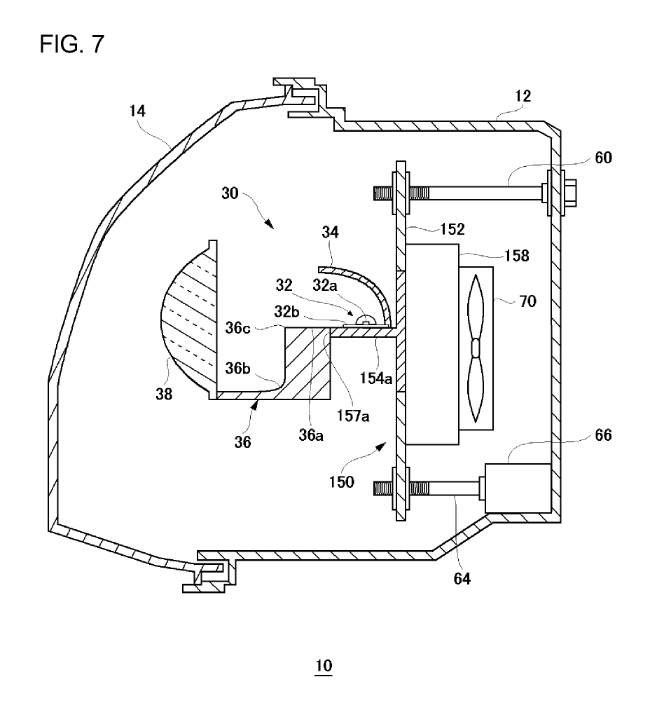

FIGS. 6A and 6B are schematic illustrations to explain a first modification of the first embodiment. FIG. 6A is a schematic illustration of a bracket, whereas FIG. 6B shows a state where a heat radiation fin and a lamp unit 30 are mounted on the bracket. FIG. 7 is a schematic vertical cross-sectional view of an automotive lamp according to the first modification of the first embodiment.

As shown in FIGS. 6A and 6B and FIG. 7, a bracket 150 of the automotive lamp 10 according to the first modification comprises an approximately plate-like body 152 and light source mounting parts 154a to 154c, protruded from one face of the body 152, which has a surface along a protruding direction on which the semiconductor light emitting device 32 is each mounted. The body 152 has screw holes 151 at predetermined peripheral positions thereof. The bracket 150 is fit to a lamp body 12 in a manner such that the screw holes 151 are engaged and screwed with aiming screws 60 and 62 (see FIG. 1) and a leveling shaft 64. A heat radiation fin 158 is provided on the other face of the body 152.

The bracket 150 includes three light source mounting parts 154a to 154c, so that three lamp units 30 can be mounted on the bracket 150. In the bracket 150, as viewed in a horizontal cross-section, the body 152 is tilted to mounting surfaces 157a to 157c of the lamp unit 30 in the light source mounting parts 154a to 154c. Accordingly, the body 152 is structured such that the body 152 is tilted greatly in the direction of a light axis or frontward and rearward directions of a vehicle. Thus the bracket 150 according to the first modification is suitably used for an automotive lamp 10 where a lamp chamber is tilted in frontward and rearward directions of a vehicle as viewed in a horizontal cross-section. Note that FIG. 6B shows only the lamp unit 30 mounted on the light source mounting part 154a. The reflector 34 of the lamp unit 30 is omitted in FIG. 6B.

In the bracket 150 according to the first modification, the light source mounting parts 154a to 154c and a part of the body 152 including regions in contact with the light source mounting parts 154a to 154c are formed of the first heat-transfer member, thus constituting a first heat-transfer member region 156. A region, other than the first heat-transfer member region 156, of the body 152 is formed of the second heat-transfer member. The first heat-transfer member region 156 is formed such that the first heat-transfer member, which forms the light source mounting parts 154a to 154c and a part of the body 152, is fit into through-holes or recesses provided in the second heat-transfer member constituting the other part of the body 152. The first heat-transfer member is so provided in the body 152 that it is interwoven with a plurality of core materials.

In the bracket 150, the heat produced by the semiconductor light emitting device 32 diffuses isotropically within the first heat-transfer region 156 from the light source mounting parts 154a to 154c toward the body 152. This is because the first heat-transfer member has an isotropic thermal conductivity. Then the heat diffused inside the first heat-transfer member region 156 is conducted to the second heat-transfer member which is in contact with the first heat-transfer member, and is then conducted to the heat radiation fin 158 after having been diffused inside the body 152. Part of the first heat-transfer member region 156 is in contact with the heat radiation fin 158, and part of heat produced by the semiconductor light emitting device 32 is diffused directly to the heat radiation fin 158 from the first heat-transfer member region 156. Then heat is exchanged between the heat conducted to the heat radiation fin 158 and the air sent from the fan 70.

### Second Modification

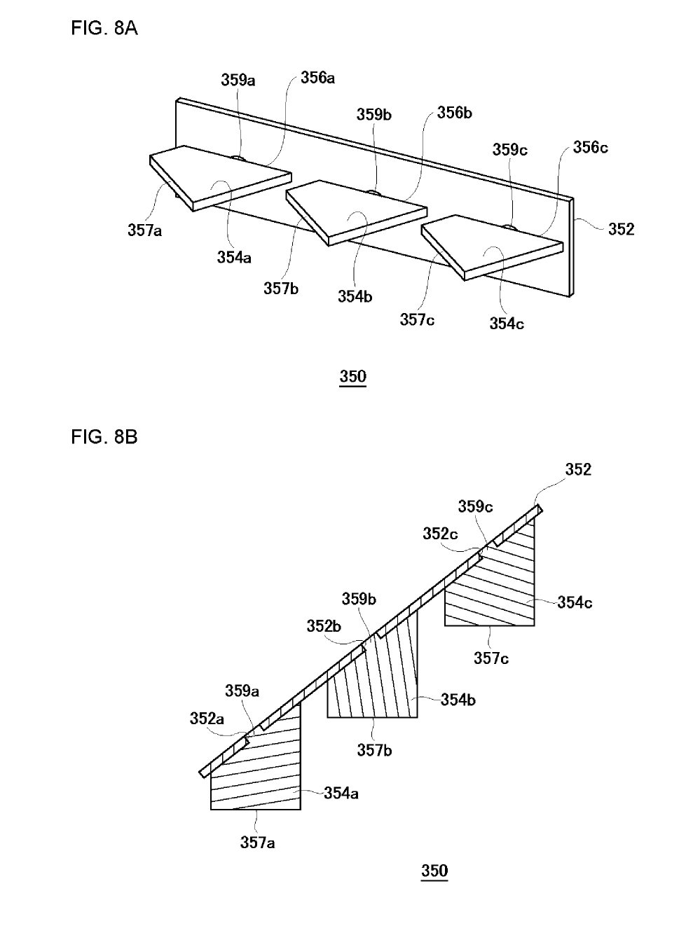

FIGS. 8A and 8B are schematic illustrations to explain a second modification of the first embodiment. FIG. 8A is a schematic illustration of a bracket, whereas FIG. 8B is a horizontal cross-sectional view of a bracket. Note that the screw holes used to mount a bracket 350 on the lamp body 12 and the heat radiation fin are omitted in FIGS. 8A and 8B.

As shown in FIGS. 8A and 8B, a bracket 350 of the automotive lamp 10 according to the second modification comprises an approximately plate-like body 352 and light source mounting parts 354a to 354c, protruded from one face of the body 352, which has a surface along a protruding direction on which the semiconductor light emitting device 32 is each mounted. In the bracket 350, as viewed in a horizontal cross-section, the body 352 is tilted to mounting surfaces 357a to 357c of the lamp unit in the light source mounting parts 354a to 354c. Accordingly, the body 352 is structured such that the body 352 is slanted greatly in the direction of a light axis or frontward and rearward directions of a vehicle.

In the bracket 350 according to the second modification, the light source mounting parts 354a to 354c are disposed apart from each other, and protrusions 359a to 359c are formed on faces of the light source mounting parts 354a to 354c abutted against one side of the body 352. The light source mounting parts 354a to 354c are formed of the first heat-transfer member, thus constituting first heat-transfer member regions 356a to 356c. Mounting through-holes 352a to 352c through which the protrusions 359a to 359c are inserted are formed in the body 352, and the body 352 are formed of the second heat-transfer member. The first heat-transfer member regions 356a to 356c are formed such that the protrusions 359a to 359c of the light source mounting parts 354a to 354c are inserted into the mounting through-holes 352a to 352c of the body 352. Thus, the protrusions 359a to 359c are interwoven with a plurality of core materials of the second heat-transfer member. Hence, the first heat-transfer member is interwoven with a plurality of core materials of the second heat-transfer member. Also, the light source mounting parts 354a to 354c are in contact with the main surface of the body 352. This prevents the light source mounting parts 354a to 354c from falling off from the body 352.

In the bracket 350, the heat produced by the semiconductor light emitting device diffuses isotropically within the first heat-transfer regions 356a to 356c from the light source mounting parts 354a to 354c toward the body 352. Then the heat diffused inside the first heat-transfer member regions 356a to 356c is conducted from the first heat-transfer member to the second heat-transfer member through the inner surface of the mounting through-holes 352a to 352c of the body 352, and is then conducted to the heat radiation fin after having been diffused inside the body 352. The top surfaces of the protrusions 359a to 359c are in contact with the heat radiation fin, and part of heat produced by the semiconductor light emitting device is diffused directly to the heat radiation fin from the first heat-transfer member regions 356a to 356c. Then heat is exchanged between the heat conducted to the heat radiation fin and the air sent from the fan.

By employing the automotive lamp 10 according to both the first modification and the second modification as described above, the automotive lamp can be made lighter-weight. At the same time, the heat produced by the semiconductor light emitting device can be efficiently diffused, thereby suppressing an excessive rise in temperature of the semiconductor light emitting device. The first and second modifications of the first embodiment also achieve the same other advantageous effects as attained by the first embodiment. In the automotive lamp according to the second modification, the amount of the first heat-transfer member contained in the bracket 350 is reduced and therefore the percentage of the second heat-transfer member in the entire bracket 350 can be increased. As a result, the automotive lamp can be made further lightweight.

### Second Embodiment

An automotive lamp according to a second embodiment differs from the first embodiment in that a direct-emitting-type lamp unit is used as a lamp unit and a bracket is so structured as to be capable of fixing the direct-emitting-type lamp unit. A description is given hereunder of the second embodiment. The structure as well as the structural components of the automotive lamp according to the second embodiment are basically the same as those according to the first embodiment. Note that the structural components identical to those in the first embodiment are denoted with the same reference numerals as those therein and therefore the repeated description thereof will be omitted as appropriate.

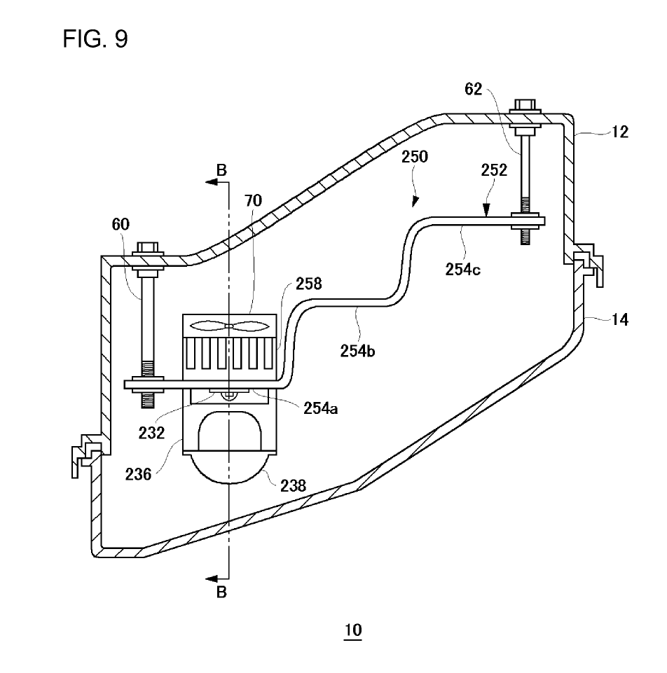

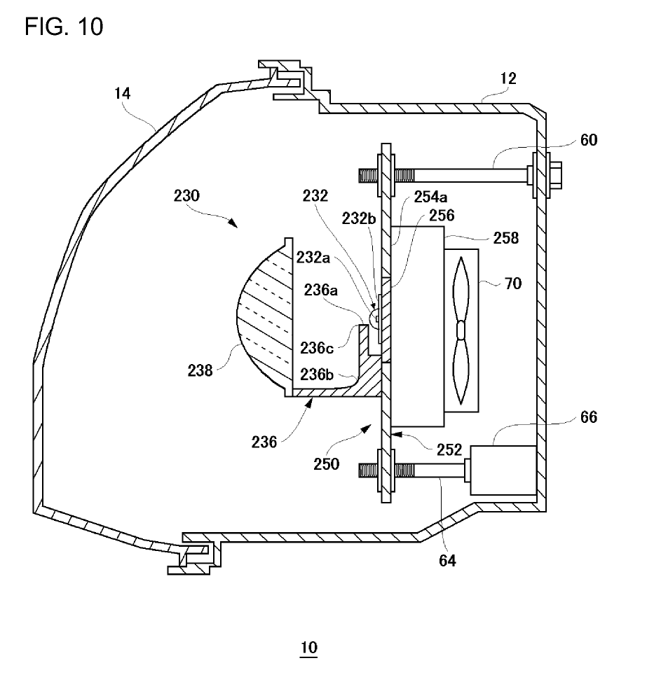

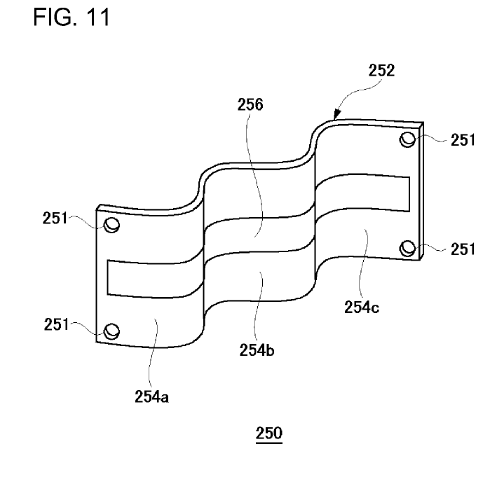

FIG. 9 is a schematic horizontal cross-sectional view of an automotive lamp according to the second embodiment. FIG. 10 is a cross-sectional view taken along the line B-B of FIG. 9. FIG. 11 is a schematic illustration showing a structure of a bracket.

As shown in FIG. 9 and FIG. 10, an automotive lamp 10 according to the second embodiment is structured such that a lamp unit 230 including a semiconductor light emitting device 232 used as a light source is housed within a lamp chamber formed by the a lamp body 12 and a translucent cover 14. Contained within the lamp chamber is a bracket 250 serving as a support member that supports the lamp unit 230. The lamp unit 230 is fixed to the bracket 250.

The lamp unit 230, which is a direct-emitting-type and projector-type lamp unit, includes a semiconductor light emitting device 232, a shade 250 fixed to the bracket 250, and a projection lens 238 held by the shade 236.

The semiconductor light emitting device 232 is a light emitting diode (LED), for instance. And the semiconductor light emitting device 232 comprises a light emitting chip 232a covered with an approximately hemispherical cap, and a thermally conductive insulating substrate 232b formed of a ceramic or the like. The semiconductor light emitting device 232 is placed on each of light source mounting parts 254a to 254c (described later) of the bracket 250 such that the illumination axis of the semiconductor light emitting device 232 faces toward the frontward direction of a vehicle which is approximately parallel to an irradiation direction (leftward in FIG. 10) of the lamp unit 230.

The shade 236 has a planar part 236a which is disposed approximately horizontally. The area in front of this planar part 36a is bent downward in a recessed manner and is structured as a bent part 236b. And the bent part 236b occupying the front part of the shade 236 is structured so that light irradiated from the semiconductor light emitting device 232 is not reflected. Also, the shade 236 has a ridge line 236c formed by the planar part 236a and the bent part 36b.

The projection lens 238 is a plano-convex aspheric lens, having a convex front surface and a plane rear surface, which projects the light irradiated from the semiconductor light emitting device 232 toward a front area of the lamp. The projection lens 38 is disposed on a light axis extending in frontward and rearward directions of a vehicle, and is fixed to the tip end of the shade 236 in a front side of a vehicle. A rear focal point of the projection lens 238 is configured, for instance, such that the rear focal point thereof approximately matches the light emitting chip 232a of the semiconductor light emitting device 232.

The light, emitted from the light emitting chip 232a, directly enters the projection lens 238. The light having entered the projection lens 238 is collected by the projection lens 238 so as to be irradiated frontward as approximately parallel light beams. Also, part of light beams are reflected by the planar part 236a with the ridge line 236c of the shade 236 as a boundary, so that a diagonal cutoff line is formed in a light distribution pattern.

As shown in FIG. 9 to FIG. 11, a bracket 250 has a body 252 which is an approximately corrugated plate shape as viewed in a horizontal cross-section. The body 252 includes light source mounting parts 254a to 254c on which the semiconductor light emitting device 232 is each mounted.

The body 252 has screw holes 251 at predetermined peripheral positions thereof. The bracket 250 is fit to the lamp body 12 in a manner such that the screw holes 251 are engaged and screwed with aiming screws 60 and 62 and a leveling shaft 64. The body 252 includes three light source mounting parts 254a to 254c, so that three lamp units 230 can be mounted thereon. Note that only the lamp unit 230, which is mounted on the light source mounting part 254a, is shown in FIG. 9.

Further, a first heat-transfer member region 256, made of a metal (e.g., aluminum), which is formed of a first heat-transfer member having an isotropic thermal conductivity is provided in the body 252 so that the first heat-transfer member region 256 contains at least part of region, of each of the light source mounting parts 254a to 254c, which is in contact with the semiconductor light emitting device 232. Regions in contact with the first heat-transfer members of the light source mounting parts 254a to 254c, for instance the regions other than the first heat-transfer member region 256 of the body 252 in the second embodiment, are formed of a second heat-transfer member having an anisotropic thermal conductivity. It is preferable that most of the bracket 250, about 80% or more in volume fraction, for instance, be formed of the second heat-transfer member.

The second heat-transfer member is a material whose mass is lighter than the first heat-transfer member, and an example thereof is carbon fiber reinforced plastic (CFRP). Also, the second heat-transfer member is of a multilayered structure where core materials (core layers) are stacked in layers. It is preferable that CFRP contains carbon fibers, having a thermal conductivity of about 320 W/mK or more, the volume fraction of which is about 20% or more. More preferably, CFRP contains carbon fibers, having a thermal conductivity of about 500 W/mK or more, the volume fraction of which is about 50% or more. The core materials are such that the multiple carbon fibers are arranged approximately in parallel with one another, and have an approximately sheet-like shape where the respective carbon fibers are bonded together using thermosetting resin such as epoxy resin.

The first heat-transfer member region 256 is formed such that the first heat-transfer member is fit into through-holes or recesses provided in the body 252. Here, the first heat-transfer member is so provided in the body 252 that it is interwoven with a plurality of core materials.

As shown in FIG. 9 and FIG. 10, a heat radiation fin 258 is provided on a face of the body 252 opposite to the face thereof on which the semiconductor light emitting device 232 is mounted. Provided inside the lamp chamber is a fan 70 that sends air toward the heat radiation fin 258 and thereby cools the heat radiation fin 258. Note that only the heat radiation fin 258 and fan 70 corresponding to the light source mounting part 254a are shown in FIG. 9.

In the structure as described above, the heat produced by the semiconductor light emitting device 32 diffuses isotropically within the first heat-transfer region 256 which is in contact with the semiconductor light emitting device 232. Then the heat inside the first heat-transfer member region 256a is conducted to a plurality of core materials in the second heat-transfer member which is in contact with the first heat-transfer member, and is conducted to the heat radiation fin 258. Part of the first heat-transfer member region 256 is in contact with the heat radiation fin 258, and part of heat produced by the semiconductor light emitting device 232 is diffused directly to the heat radiation fin 258 from the first heat-transfer member region 256. Then heat is exchanged between the heat conducted to the heat radiation fin 258 and the air sent from the fan 70.

A sheet-like securing member may be so provided as to cover the surface of the body 252 and the surface of the first heat-transfer member region 256. By employing this structure, the first heat-transfer member can be prevented from falling off from the second heat-transfer member. The shape of the securing member is not limited to any particular one. For example, screw holes are disposed so that the axes of the screw holes coincide with the first heat-transfer member and the second heat-transfer member, respectively, and the first heat-transfer member and the second heat-transfer member are fixed by inserting the screws into these screw holes. Also, the heat radiation fin 58 may be interwoven with each core material constituting the body 252 in a manner such that an end of the heat radiation fin 258 on a body 252 side is buried into or penetrated through the body 252. This structure enables the heat conducted to each core material from the semiconductor light emitting device 232, to conduct more efficiently to the heat radiation fin 258.

The operations performed in relation to and the advantages achieved by the structure, according to the second embodiment, as heretofore described are summed up as follows. That is, in the automotive lamp 10 according to the second embodiment, the first heat-transfer member region 256 formed of the first heat-transfer member having an isotropic thermal conductivity is provided in a region, in the bracket 250, which is in contact with the semiconductor light emitting device 232. Also, the region, other than the first heat-transfer member region 256, of the bracket 250 are formed of the second heat-transfer member having an anisotropic thermal conductivity and a lighter weight than the first heat-transfer member. Hence, the automotive lamp 10 is lightweight and the heat produced by the semiconductor light emitting device 232 can be efficiently diffused. As a result, the drop in luminance efficiency of the semiconductor light emitting device 232 can be suppressed and the product reliability of the automotive lamp 10 can be improved.

Similarly to the first embodiment, the first heat-transfer member employed in the automotive lamp 10 according to the second embodiment is arranged such that the first heat-transfer member is interwoven with a plurality of core materials constituting the second heat-transfer member. This structure allows a plurality of core materials to contribute to diffusing the heat produced by the semiconductor light emitting device 232, so that the heat can be diffused more efficiently. Also, suppose that most of the bracket 250, about 80% or more in volume, for instance, is formed of the second heat-transfer member or suppose that CFRP, which is a second heat-transfer member, preferably contains carbon fibers, of about 20% or more in volume fraction, having a thermal conductivity of about 320 W/mK or more, or, more preferably contains carbon fibers, of about 50% or more in volume fraction, having a thermal conductivity of about 500 W/mK or more. Then the automotive lamp 10 can be made lighter weight and the thermal conductivity of the automotive lamp 10 can be further improved.

Furthermore, a laying surface on which a semiconductor light emitting device 232 is to be placed is provided on the first heat-transfer member region 256 formed of the first heat-transfer member. Thus, the first heat-transfer member is easily processed as compared with the second heat-transfer member. As a result, the positioning and the like of the semiconductor light emitting device 232 can be performed more easily and therefore the rise in the number of manufacturing processes and manufacturing cost can be suppressed. Also, the provision of the securing member that fixes the first heat-transfer member and the second heat-transfer member relative to each other prevents the first heat-transfer member from falling off from the second heat-transfer member.

### Modification

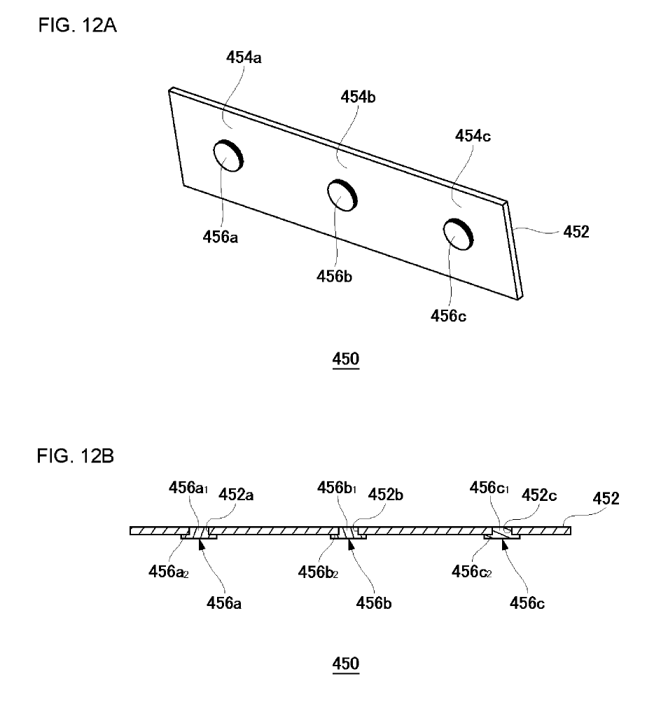

An automotive lamp 10 according to a modification of the second embodiment will be described hereunder. FIGS. 12A and 12B are schematic illustrations to explain a modification of the second embodiment. FIG. 12A is a schematic illustration of a bracket, whereas FIG. 12B shows a horizontal cross-sectional view of the bracket. Note that the screw holes, provided in a body 452, which is used to mount a bracket 450 on the lamp body 12 and the heat radiation fin provided in the body 452 are omitted in FIGS. 12A and 12B. The body 452 is of approximately flat plate-like.

As shown in FIGS. 12A and 12B, the bracket 450 of the automotive lamp 10 according to the present modification has an approximately flat plate-like body 452. The body 452 includes light source mounting parts 454a to 454c on which a semiconductor light emitting device is each mounted. And first heat-transfer member regions 456a to 456c formed of the first heat-transfer member are so provided in the body 452 as to contain at least part of region, of each of the light source mounting parts 454a to 454c, which is in contact with the semiconductor light emitting device. The first heat-transfer member regions 456a to 456c are disposed apart from each other. The first heat-transfer member constituting the first heat-transfer member regions 456a to 456c comprises cylindrical cylinder parts 456a1 to 456c1 and anchoring parts 456a2 to 456c2. Here, the anchoring part 456a2 has a diameter larger than that of the cylinder parts 456a1, and is provided on one top surface of the cylinder part 456a1. The same applies to the anchoring parts 456b2 and 456c2 that pair respectively with the cylinder parts 456b1 and 456c1. In other words, each cylinder part combined with each anchoring part is approximately T-shaped as viewed in a horizontal cross-section. Mounting through-holes 452a to 452c through which the cylinder parts 456a1 to 456c1 are inserted are formed in the body 452, and the body 452 are formed of the second heat-transfer member.

The first heat-transfer member regions 456a to 456c are formed such that the cylinder parts 456a1 to 456c1 of the first heat-transfer member are inserted into the mounting through-holes 452a to 452c of the body 452. Thus, the first heat-transfer member is interwoven with a plurality of core materials of the second heat-transfer member in the cylinder parts 456a1 to 456c1. The diameter of each of the anchoring parts 456a2 to 456c2 is larger than the diameter of each of the mounting through-holes 452a to 452c, and the anchoring parts 456a2 to 456c2 are in contact with the main surface of the body 452. This prevents the first heat-transfer member constituting the first heat-transfer member regions 456a to 456c from falling off from the body 452. The shape of the cylinder parts 456a1 to 456c1 may be other than the cylindrical shape, for example, a square pole.

In the bracket 450, the heat produced by the semiconductor light emitting device diffuses isotropically within the first heat-transfer regions 456a to 456c. Then the heat diffused inside the first heat-transfer member regions 456a to 456c is conducted from the first heat-transfer member to a plurality of core materials formed of the second heat-transfer member through the inner surface of the mounting through-holes 452a to 452c of the body 452, and is then conducted to the heat radiation fin after having been diffused inside the body 452. Part of the first heat-transfer member regions 456a to 456c, namely the top surface of the cylinder parts 456a1 to 456c1 opposite to the anchoring parts 456a2 to 456c2, is in contact with the heat radiation fin. Thus, parts of heat produced by the semiconductor light emitting device is diffused directly to the heat radiation fin. Then heat is exchanged between the heat conducted to the heat radiation fin and the air sent from the fan.

By employing the automotive lamp 10 according to the above-described modification of the second embodiment, the automotive lamp can be made lighter-weight. At the same time, the heat produced by the semiconductor light emitting device can be efficiently diffused, thereby suppressing an excessive rise in temperature of the semiconductor light emitting device. The modification of the second embodiment also achieves the same other advantageous effects as attained by the second embodiment. Furthermore, in the automotive lamp according to the modification of the second embodiment, the amount of the first heat-transfer member contained in the bracket 450 is reduced and therefore the percentage of the second heat-transfer member in the entire bracket 450 can be increased. As a result, the automotive lamp can be made further lightweight.

The present invention is not limited to the above-described embodiments and modifications only, and it is understood by those skilled in the art that various further modifications such as changes in design may be made based on their knowledge and the embodiments added with such modifications are also within the scope of the present invention.

In the above-described embodiments, the lamp units 30 and 230 are low-beam lamp unit such that the diagonal cutoff line is formed in a light distribution pattern projected onto a front part of a vehicle. However, the present embodiments are not limited thereto and, for example, the lamp unit may be a high-beam lamp unit such that no oblique cutoff line is formed.

The automotive lamp 10 according to each of the above-described embodiments and modifications is applicable and used for various types of lamps, for example, a supplementary headlamp such as an automotive headlamp, tail lamp, fog lamp, driving lamp or the like.

What is claimed is:

1. An automotive lamp comprising:
a semiconductor light emitting device used as a light source; and
a support member which supports the semiconductor light emitting device, the supporting member including:
a first heat-transfer member having an isotropic thermal conductivity in at least part of region thereof in contact with the semiconductor light emitting device; and
a second heat-transfer member having an anisotropic thermal conductivity in a region thereof in contact with the first heat-transfer member.

2. An automatic lamp according to claim 1, wherein the second heat-transfer member is structured such that laminated core materials are stacked together, and has an anisotropic thermal conductivity in an extending direction of the core material, and
wherein the first heat-transfer member is so provided in such a manner as to be interwoven with a plurality of the core materials.

3. An automotive lamp according to claim 1, wherein the support member includes an approximately plate-like body and a light source mounting part, protruded from one face of the body , which has a surface along a protruding direction on which the semiconductor light emitting device is mounted.

4. An automotive lamp according to claim 2, wherein the support member includes an approximately plate-like body and a light source mounting part, protruded from one face of the body , which has a surface along a protruding direction on which the semiconductor light emitting device is mounted, and
wherein the core materials extend from the body to the light source mounting part.

5. An automotive lamp according to claim 4, wherein a heat radiation fin is provided on the other face of the body.

6. An automotive lamp according to claim 1, further comprising a securing member which fixes the first heat-transfer member and the second heat-transfer member relative to each other.

7. An automotive lamp according to claim 1, wherein the mass of the second heat-transfer member is lighter than that of the first heat-transfer member.

8. An automotive lamp according to claim 1, wherein the second heat-transfer member is carbon fiber reinforced plastic that contains carbon fibers, having a thermal conductivity of approximately 320 W/mK or more, the volume fraction of which is approximately 20% or more.

9. An automotive lamp comprising:
a semiconductor light emitting device used as a light source; and
a support member which supports the semiconductor light emitting device, the supporting member including:
a first heat-transfer member which diffuses the heat produced by the semiconductor light emitting device; and
a second heat-transfer member, having an anisotropic thermal conductivity, which is in contact with the first heat-transfer member,
wherein the first heat-transfer member diffuses the heat of the semiconductor light emitting device in a direction where the heat produced by the semiconductor light emitting device is less likely to diffuse due to the anisotropic thermal conductivity of the second heat-transfer member.

10. An automotive lamp according to claim 9, wherein the second heat-transfer member has a hole or recess,
the second heat-transfer member comes into contact with the first heat-transfer member in a manner such that the first heat-transfer member is fit into the hole or recess, and the semiconductor light emitting device is fixed to the first heat-transfer member.

11. An automotive lamp according to claim 1, wherein the support member contains the second heat-transfer member of approximately 80% or more in volume fraction.

12. An automotive lamp according to claim 1, wherein the second heat-transfer member is carbon fiber reinforced plastic that contains carbon fibers, having a thermal conductivity of approximately 500 W/mK or more, the volume fraction of which is approximately 50% or more.

13. An automotive lamp according to claim 3, wherein
a heat radiation fin is provided on the other face of the body,
wherein part of the body and the light source mounting part are formed of the first heat-transfer member, and
wherein the first heat-transfer member is in contact with the heat radiation fin.
